(19) United States
(12) Patent Application Publication
(10) Pub. No.: US 2016/0125400 A1
(43) Pub. Date: May 5, 2016

(54) SYSTEMS AND METHODS FOR GEO COMPONENT FRAUD DETECTION FOR CARD-PRESENT TRANSACTIONS

(71) Applicant: MasterCard International Incorporated, Purchase, NY (US)

(72) Inventors: Po Hu, Norwalk, CT (US); Qian Wang, Ridgefield, CT (US); Tong Zhang, Greenwich, CT (US)

(21) Appl. No.: 14/529,386

(22) Filed: Oct. 31, 2014

(51) Int. Cl. G06Q 20/38; G06Q 20/34

(52) U.S. Cl. CPC G06Q 20/382; G06Q 20/34

(57) ABSTRACT

A method and system for evaluating a card-present payment card transaction for fraud using a computer device coupled to a database are provided. The method includes determining a home activity region for a cardholder using payment card transaction data for the cardholder, receiving a payment card transaction authorization request, and determining a payment card activity location of the received payment card transaction authorization request. The method also includes comparing the determined payment card activity location to the determined home activity region, determining if the determined payment card activity location is within the determined home activity region using a at least one of a selectable threshold and a determined threshold, and outputting a score for the received payment card transaction authorization request based on the determination of whether the payment card activity location is within the determined home activity region.

### BACKGROUND

This disclosure relates generally to payment card fraud and, more particularly, to computer systems and computer-based methods for automated payment card fraud detection using a cardholder's spending behavior and geographical location to detect fraudulent attempted transactions.

Payment instruments, such as credit cards, debits cards, ATM (Automated Teller Machine) cards, and the like are commonly used by account holders to make purchases and/or engage in other transactions at stores, shops, ATMs and/or other like physical locations. Typically, each such instrument or card carries various information associated with the particular card (e.g., an account holder name, a card number, an expiration date, etc.). For example, this information may be imprinted on the card, encoded on a magnetic strip, or otherwise contained on the card.

A so called “card-present transaction” refers to a transaction in which the card is physically present at the time and place of the transaction. Commonly, in a card-present transaction, the card being presented for payment or otherwise used in connection with the transaction is swiped, scanned or otherwise read (e.g., by a point-of-sale (POS) terminal or other like card reader), to obtain the relevant card information (i.e., card number, expiration date, account holder name, etc.). Prior to completing the transaction, the obtained card information and a set of corresponding transaction details are forwarded to or otherwise submitted over a transaction processing network for approval (e.g., by the institution that issued the card). Commonly, the transaction details include a transaction amount and an identification of the merchant, seller, ATM, POS terminal or the like that is requesting the approval to complete the transaction. The aforementioned identification is typically associated with a street address or other like indicator of the location at which the transaction is being conducted. Cardholders typically shop and/or use their payment cards in locations in a relatively small geographical region around their residence and/or place of business. Fraudulent transaction attempts are frequently attempted at locations remote from the cardholder's home region. Unexpected or out-of-the-ordinary use of a payment card remote from a cardholder's home region may be cause to suspect a fraudulent transaction attempt.

While the aforementioned payment instruments or cards generally provide account holders a measure of convenience to conduct various transactions, they are susceptible to fraudulent and/or other types of unauthorized use. For example, an unauthorized user may attempt to make purchases or conduct other transactions with a stolen or otherwise ill-gotten payment instrument or card. To protect against these fraudulent and/or unauthorized uses, various approaches have been previously implemented in an effort to ensure that only the account holder named or otherwise identified on the card is able to use the card. For example, the card may carry the account holder's signature. Accordingly, a signature provided by the user of the card at the time of the transaction can be compared to the signature on the card to verify that the user is in fact the account holder. In another example, the user of the card may be required to supply a PIN (Personal Identification Number) or other secret code before a transaction can be initiated with the card. In yet another example, the user of the card may be required to present some secondary form of ID indicating that they are in fact the account holder named or otherwise identified on the card.

Some degree of security against fraudulent or otherwise unauthorized card use is provided by the foregoing solutions. However, these solutions are limited in various respects. For example, signatures can be forged, PINs can guessed or otherwise become compromised, and false secondary IDs can be created or obtained by unscrupulous individuals.

### BRIEF DESCRIPTION

In one embodiment, a computer-based method for evaluating a card-present payment card transaction for fraud is implemented using a computer device coupled to a memory device. The method includes determining a home activity region for a cardholder using card-present payment card transaction data for the cardholder, receiving a payment card transaction authorization request wherein the authorization request includes an identification of an account associated with a payment card used in the payment card transaction, and determining a payment card activity location of the received payment card transaction authorization request. The method also includes comparing the determined payment card activity location to the determined home activity region, determining if the determined payment card activity location is within the determined home activity region using a at least one of a selectable threshold and a determined threshold, and outputting a score for the received payment card transaction authorization request based on the determination of whether the payment card activity location is within the determined home activity region.

In another embodiment, a computer system for processing data includes a memory device and a processor in communication with the memory device. The computer system is programmed to store card-present payment card transaction data received from a plurality of merchants for a cardholder associated with a unique primary account number, determine a home activity region of a cardholder using the stored card-present payment card transaction data, and receive a payment card transaction authorization request, the authorization request including an identification of an account associated with a payment card used in the payment card transaction. The computer system is also programmed to determine a payment card activity location of the received payment card transaction authorization request, compare the determined payment card activity location to the determined home activity region, and determine if the determined payment card activity location is within the determined home activity region using a at least one of a selectable threshold and a determined threshold. The computer system is also programmed to output a score for the received payment card transaction authorization request based on the determination of whether the payment card activity location is within the determined home activity region.

In yet another embodiment, one or more non-transitory computer-readable storage media has computer-executable instructions embodied thereon, wherein when executed by at least one processor, the computer-executable instructions cause the processor to store card-present payment card transaction data received from a plurality of merchants for a cardholder associated with a unique primary account number, determine a home activity region of a cardholder using the stored card-present payment card transaction data, and receive a payment card transaction authorization request from a merchant point of sale (POS) device, the authorization request including an identification of an account associated with a payment card used in the payment card transaction. The computer-executable instructions further cause the processor to determine a payment card activity location of the received payment card transaction authorization request, compare the determined payment card activity location to the determined home activity region, determine if the determined payment card activity location is within the determined home activity region using a at least one of a selectable threshold and a determined threshold, and output a score for the received payment card transaction authorization request based on the determination of whether the payment card activity location is within the determined home activity region.

### BRIEF DESCRIPTION OF THE DRAWINGS

FIGS. 1-9 show example embodiments of the methods and systems described herein.

FIG. 1 is a schematic diagram illustrating an example multi-party payment card industry system having a geo-component fraud evaluation module for enabling payment-by-card transactions between merchants and cardholders in accordance with an embodiment of the present disclosure.

FIG. 2 is a simplified block diagram of an example payment processing system including a plurality of computer devices including the geo-component fraud evaluation module in accordance with one example embodiment of the present disclosure.

FIG. 3 is an expanded block diagram of an example embodiment of a server architecture of the payment processing shown in FIG. 2 in accordance with one example embodiment of the present disclosure.

FIG. 4 illustrates an example configuration of a client system shown in FIGS. 2 and 3.

FIG. 5 illustrates an example configuration of a server system shown in FIGS. 2 and 3.

FIG. 6 illustrates a data flow diagram of the geo-component fraud evaluation module shown in FIG. 1.

FIG. 7 is a flow chart of a method of evaluating fraud in a card-present transaction using the geo-component fraud evaluation module shown in FIG. 1.

FIG. 8 is a diagram of components of one or more example computing devices that may be used in the environment shown in FIG. 2.

FIG. 9 is an illustration of a heat map that may be used with the geo-component fraud evaluation module shown in FIG. 1 in accordance with an example embodiment of the present disclosure.

### DETAILED DESCRIPTION

Embodiments of the methods and systems described herein relate to evaluating fraud in a card-present transaction using a geo-component evaluation module. In the example embodiment, the system and method includes determining a home activity region for a cardholder using card-present payment card transaction data for the cardholder. The home activity region is a region where the cardholder initiates most of their card-present payment card purchases and is partially based on an industry of the merchant. For example, the home activity region associated with merchants in the hardware industry, for example, is not necessarily the same or even overlapping with the home activity region associated with merchants in the grocery industry for a particular cardholder. The method also includes receiving a payment card transaction authorization request from, for example, a merchant point of sale (POS) device wherein the authorization request includes an identification of an account associated with a payment card used in the payment card transaction, and determining a payment card activity location of the received payment card transaction authorization request. The method further includes comparing the determined payment card activity location to the determined home activity region, determining if the determined payment card activity location is within the determined home activity region using a at least one of a selectable threshold and a determined threshold, and outputting a score for the received payment card transaction authorization request based on the determination of whether the payment card activity location is within the determined home activity region.

An industry code for each merchant that the cardholder initiates a transaction with is used to establish a home activity region for that industry code. As stated above, the home activity region for a particular cardholder for merchant in a particular industry may be and typically is different than the cardholder's home activity region for another industry. Further examples include, a home activity region for a cardholder for the grocery industry may be localized to a relatively small region, which would be close to the cardholder's residence. However, a home activity region for a cardholder for the automotive industry may be localized to a corridor region coinciding with a route the cardholder takes between the cardholder's residence and work location.

Additionally, for a cardholder, any or all of the home activity regions may be temporarily suspended from fraud evaluation consideration or may be relocated for a period of time. Such a temporary change in the home activity regions may be used during a period when it is determined that the cardholder has left the cardholder's determined home activity regions because of business trip, vacation, or other temporary absence from the cardholder's usual home activity regions. The temporary change may be determined through transaction data or through input from the cardholder. For example, when making airline reservations, hotel reservations, car rental reservations, or other travel related activities, a “hold” is typically placed on the cardholder's payment card account for an anticipated amount of the eventual charge. This hold may be detected in the transaction data received to alert the geo-component fraud evaluation module that a potential temporary change in home activity region may be anticipated. In some cases, destination information may be available to predetermine the likely temporary home activity region, at least to a general area. For example, a hotel or rental car reservation hold contemporaneous with an airline reservation hold may permit a determination of the likely destination from the merchant information associated with the holds. In other cases, the merchant information may reflect a central clearinghouse location for a hotel or car rental chain, which may not be useful in ascertaining a likely destination location. Automated or manual contact with the cardholder may be made to determine or verify the likely destination.

In various embodiments, a fraud heat-map is generated to facilitate a fraud determination. The fraud heat-map includes fraud information found in the historical transaction data for each of the merchants and based on the merchants geo-location. The geo-location data can be latitude-longitude information of the merchant, the merchant's zip code, or the merchant's landmark name. The landmark name may refer to the merchant's location by a notable landmark, such as, but not limited to, a shopping center, neighborhood, or town or city name. A data structure such as, a table is created for all the merchants where transactions can happen, which is correlated to a number or frequency of fraud incidents that were recorded in a past period of time, for example, three months, for each of the merchants, or on the aggregated zip code level or city level.

For each new transaction, in addition to determining a distance between the card holders home activity region, a determination of the propensity of fraud in that region is also made. If the region where the transaction occurred has many fraud incidents in the recent past, this is combined with the results of the distance from the determined payment card activity location to the determined home activity region to determine a final score for the probability of fraud.

For example, if the cardholder lives in a zip code area where many instances of fraud are recorded, even though the cardholder is not out of the cardholder's home activity region, the transaction will still be measured by the heat map method as being suspicious. In contrast, a traveler traveling to a safe area where fraud incident is rare, may get a recommendation for approval of the transaction. Using a distance from the cardholder home activity region analysis method and the heat map analysis method in combination permits more accurate predictions and results in less false positives.

The methods and systems described herein may be implemented using computer programming or engineering techniques including computer software, firmware, hardware or any combination or subset thereof, the technical effect of the methods and systems may be achieved by performing at least one of the following steps: (a) determining a home activity region for a cardholder using card-present payment card transaction data for the cardholder, (b) receiving a payment card transaction authorization request from a merchant point of sale (POS) device, the authorization request including an identification of an account associated with a payment card used in the payment card transaction, (c) determining a payment card activity location for the received payment card transaction authorization request, (d) comparing the determined payment card activity location to the determined home activity region, (e) determining if the determined payment card activity location is within the determined home activity region using a at least one of a selectable threshold and a determined threshold, and (f) outputting a score for the received payment card transaction authorization request based on the determination of whether the payment card activity location is within the determined home activity region.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

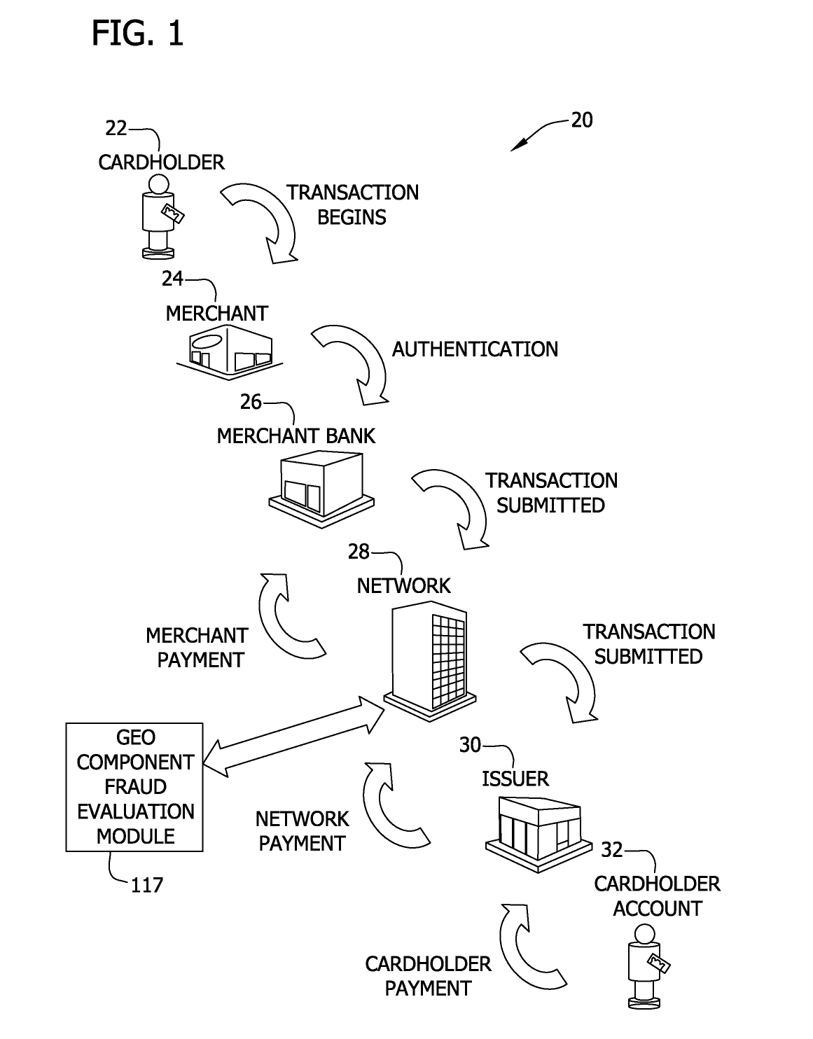

FIG. 1 is a schematic diagram illustrating an example multi-party payment card industry system having a geo-component fraud evaluation module for enabling payment-by-card transactions between merchants and cardholders in accordance with an embodiment of the present disclosure. Embodiments described herein may relate to a financial transaction card system, such as a payment card network operated by MasterCard International Incorporated. The payment card network, as described herein, is a four-party payment card interchange network that includes a plurality of special purpose processors and data structures stored in one or more memory devices communicatively coupled to the processors, and a set of proprietary communications standards promulgated by MasterCard International Incorporated for the exchange of financial transaction data and the settlement of funds between financial institutions that are members of the payment card network.

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment processing system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

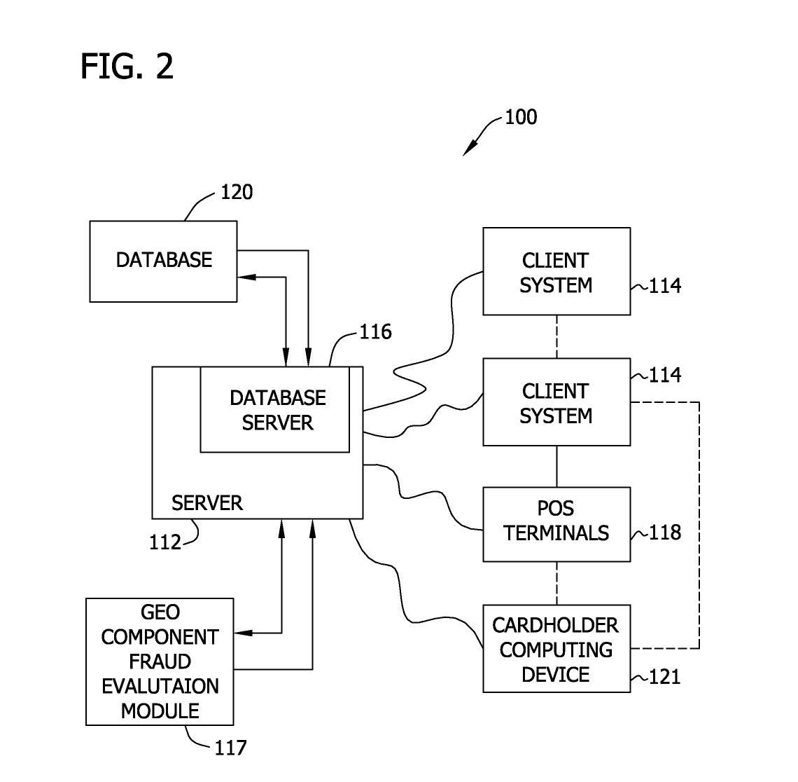

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

For debit card transactions, when a request for a PIN authorization is approved by the issuer, the consumer's account is decreased. Normally, a charge is posted immediately to a consumer's account. The issuer 30 then transmits the approval to the merchant bank 26 via the payment network 28, with ultimately the merchant 24 being notified for distribution of goods/services, or information or cash in the case of an ATM.

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, payment card home activity region information, information regarding the purchased item and/or service, and/or other suitable information, is associated with a transaction and transmitted between parties to the transaction as transaction data, and may be stored by any of the parties to the transaction. In the example embodiment, when cardholder 22 purchases goods or services in a card-present transaction, geolocation information of the point of sale (POS) or the merchant is transmitted to a geo-component fraud evaluation module 117 for evaluating a card-present payment card transaction for fraud. The geolocation is determined based on transaction data acquired at the time of the transaction, for example from the POS device or merchant input, cardholder computing device data, for example, smart phone GPS or other location data acquired before or during the transaction, other transaction data (e.g. merchant ID) in, for example, a look-up process, or other source of geolocation information. When interchange network 28 receives the geolocation information, interchange network 28 routes the geolocation information to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

FIG. 2 is a simplified block diagram of an example payment processing system 100 including a plurality of computer devices, such as server system 112, client systems 114, geo-component fraud evaluation module 117, and cardholder computing device 121 in accordance with one embodiment of the present disclosure. In one embodiment payment system 100 implements a process to validate a payment card transaction. More specifically, geo-component fraud evaluation module 117 in communication with server system 112 is configured to receive card-present payment card transaction data from a plurality of merchants for cardholders associated with respective unique primary account numbers. Using the location information contained within the received card-present payment card transaction data, geo-component fraud evaluation module 117 is configured to determine a home activity region of a cardholder. The home activity region may also be specific to a particular industry. For example, a first home activity region may be determined for a hardware or home improvement industry. A second home activity region may be determined for a grocery industry. The borders of each industry related home activity region for a single cardholder may or may not coincide. A cardholder may use grocery stores relatively close to their residence whereas they may also use home improvement stores located farther away, such that the home activity region related to the home improvement industry is larger than the home activity region related to the grocery industry. Geo-component fraud evaluation module 117 is also configured to receive a payment card transaction authorization request from a merchant point of sale (POS) device wherein the authorization request includes an identification of an account associated with a payment card used in the payment card transaction. Geo-component fraud evaluation module 117 is further configured to determine a payment card activity location of the received payment card transaction authorization request. For example, the payment card transaction authorization request may include a merchant address or location of the POS device associated with the merchant. Other geolocation information may also be used to ascertain the location of the payment card transaction. Geo-component fraud evaluation module 117 is also configured to compare the determined payment card activity location to the determined home activity region and determine if the determined payment card activity location is within the determined home activity region using a at least one of a selectable threshold and a determined threshold. Geo-component fraud evaluation module 117 is further configured to output a score for the received payment card transaction authorization request based on the determination of whether the payment card activity location is within the determined home activity region. The score may be used by the issuer or merchant to authorize or deny the payment card transaction.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 118, which may be connected to client systems 114 and may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data. Database 120 may store raw address data, formatted address data, standardized address data, standard address data, and/or geolocation data in any of various formats and/or coordinate systems associated with a merchant and/or issuer for processing according to the method described in the present disclosure.

In the example embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with interchange network 28. In the example embodiment, server system 112 is associated with a network interchange, such as interchange network 28, and may be referred to as an interchange computer system. Server system 112 may be used for processing transaction data. In addition, client systems 114 and/or POS 118 may include a computer system associated with at least one of an online bank, a bill payment outsourcer, an acquirer bank, an acquirer processor, an issuer bank associated with a transaction card, an issuer processor, a remote payment processing system, a biller, and/or geo-component fraud evaluation module 117. Geo-component fraud evaluation module 117 may be associated with interchange network 28 or with an outside third party in a contractual relationship with interchange network 28. Accordingly, each party involved in processing transaction data are associated with a computer system shown in system 100 such that the parties can communicate with one another as described herein.

Using the interchange network, the computers of the merchant bank or the merchant processor will communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, or other devices, etc.

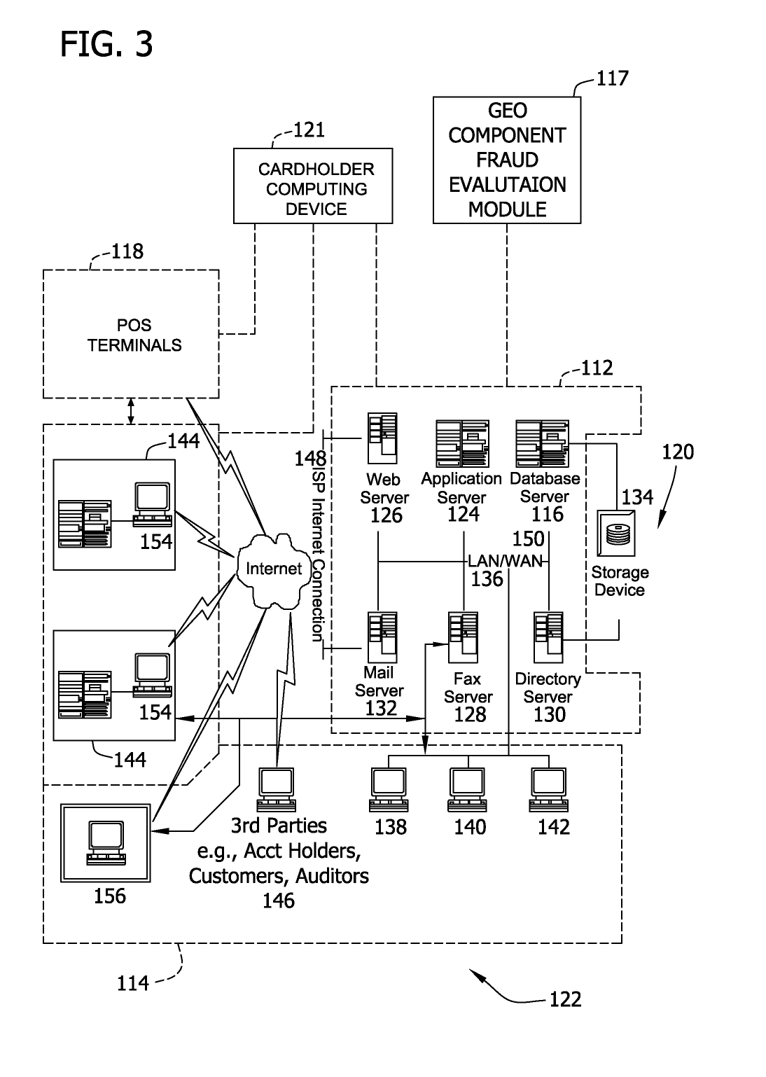

FIG. 3 is an expanded block diagram of an example embodiment of a server architecture of a processing system 122 including other computer devices in accordance with one embodiment of the present disclosure. Components in system 122, identical to components of system 100 (shown in FIG. 2), are identified in FIG. 3 using the same reference numerals as used in FIG. 2. System 122 includes server system 112, client systems 114, and POS terminals 118. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties (e.g., account holders, customers, auditors, developers, consumers, merchants, acquirers, issuers), 146 using an ISP Internet connection 148. The communication in the example embodiment is illustrated as being performed using the Internet, however, any other wide area network (WAN) type communication can be utilized in other embodiments (i.e., the systems and processes are not limited to being practiced using the Internet). In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

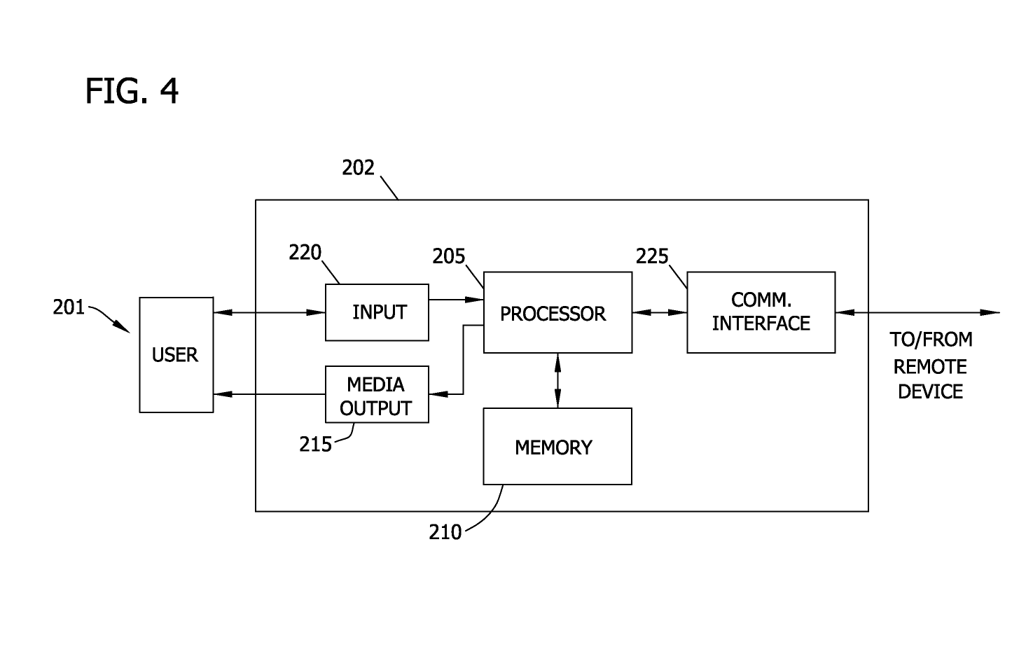

FIG. 4 illustrates an example configuration of a user system 202 operated by a user 201, such as cardholder 22 (shown in FIG. 1). User system 202 may include, but is not limited to, client systems 114, 138, 140, and 142, POS terminal 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

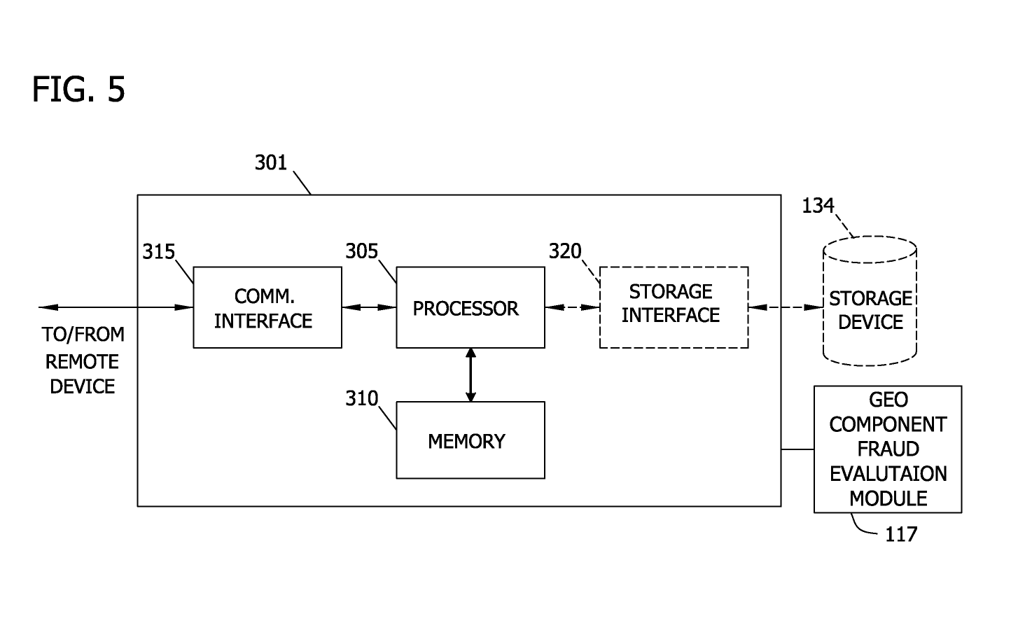

FIG. 5 illustrates an example configuration of a server system 301 such as server system 112 (shown in FIGS. 2 and 3). Server system 301 may include, but is not limited to, database server 116, transaction server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

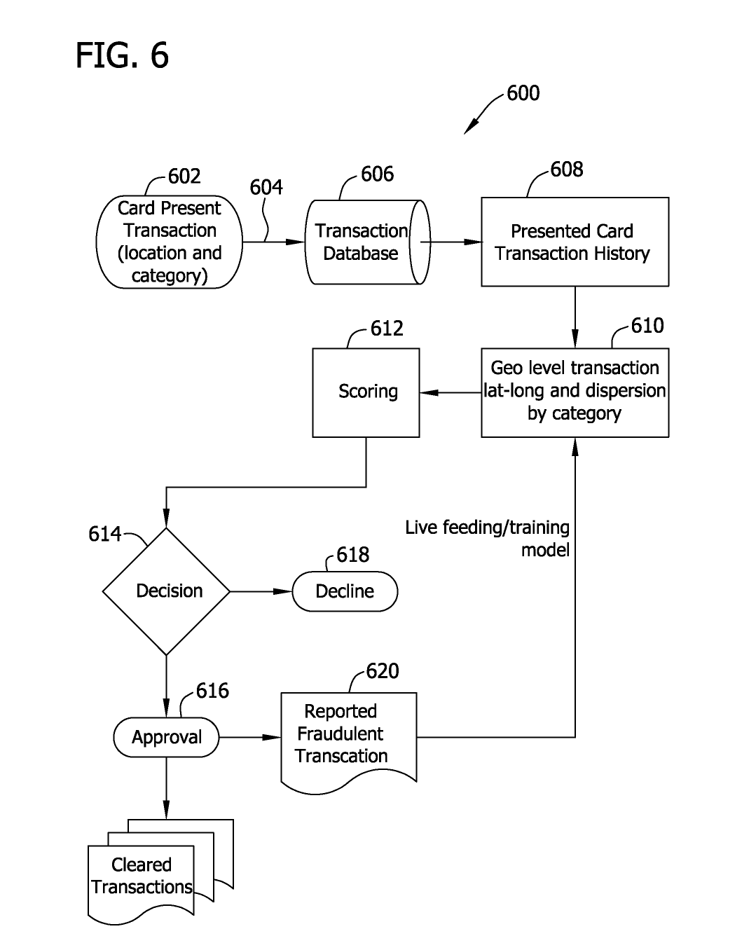

FIG. 6 illustrates a data flow diagram 600 of geo-component fraud evaluation module 117 (shown in FIG. 1). In the example embodiment, a card-present transaction 602 is attempted at a merchant site using for example, a point-of sale (POS) device (not shown in FIG. 6). Predetermined data is collected from a cardholder attempting card-present transaction 602. The predetermined data includes for example, data included on a face or reverse of a payment card presented during card-present transaction 602, on a magnetic strip of the card, on a smart chip on the card, from cardholder 22 or combinations of the above. Additional data may also be received by the merchant and included in the predetermined data. The predetermined data is forwarded 604 along with purchase data, for example, information relating to the current purchase, to for example, network 28 for processing. Network 28 is in communication with geo-component fraud evaluation module 117 and, together or independently, a transaction database 606 is accessed and a transaction history 608 for the presented card is generated.

A home activity region and dispersions by each category for a selectable time period are computed 610. The location and dispersion of each category determines the customer normal or typical shopping activity region. A score 612 that relates the current transaction location to the typical shopping activity region is generated will determine if the current transaction is away beyond the normal shopping area. Score 612 may be based on a distance between the current transaction location to the typical shopping activity region of cardholder 22. Score 612 may also be based on atypical factors such as a temporary shift in the typical shopping activity region of cardholder 22, such as, during periods when cardholder 22 is away from his typical shopping activity region temporarily on, for example, business or vacation. Such atypical factors may be determined using data stored in transaction database 606. If, for example, cardholder 22 has purchased an airline ticket, hotel rental, car rental, or combinations of the above, geo-component fraud evaluation module 117 may adjust score 612 to allow for the possibility that the current transaction location is outside the typical shopping activity region of cardholder 22 because cardholder 22 is traveling. Score 612 is provided to an authorization request approval entity, such as, issuer 30, merchant 24, or other entity for a decision 614 to approve 616 or decline 618 the transaction. Approved transactions 616 are completed being processed until cleared.

If a fraudulent transaction 620 is reported for a transaction which was approved using geo-component fraud evaluation module 117, feedback relating to the fraud is transmitted back to block 610 to improve scoring 612.

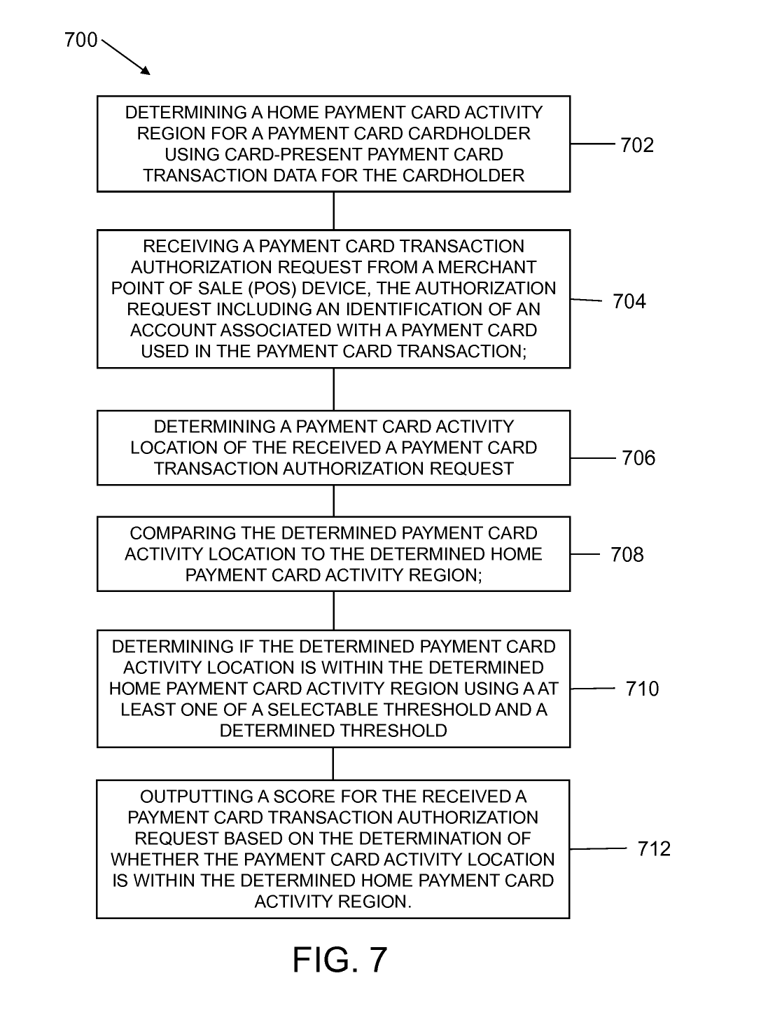

FIG. 7 is a flow chart of a method 700 of evaluating fraud in a card-present transaction using a geo-component. In the example embodiment, method 700 includes determining 702 a home activity region for a cardholder using card-present payment card transaction data for the cardholder. Home activity region is a region that indicates where cardholder 22 is mostly likely to make purchases and is partially based on an industry of the merchant. For example, the home activity region associated with merchants in the hardware industry, for example, is not necessarily the same or even overlapping with the home activity region associated with merchants in the grocery industry for a particular cardholder 22. Method 700 also includes receiving 704 a payment card transaction authorization request from a merchant point of sale (POS) device wherein the authorization request includes an identification of an account associated with a payment card used in the payment card transaction and determining 706 a payment card activity location of the received payment card transaction authorization request. Method 700 further includes comparing 708 the determined payment card activity location to the determined home activity region, determining 710 if the determined payment card activity location is within the determined home activity region using a at least one of a selectable threshold and a determined threshold, and outputting 712 a score for the received payment card transaction authorization request based on the determination of whether the payment card activity location is within the determined home activity region.

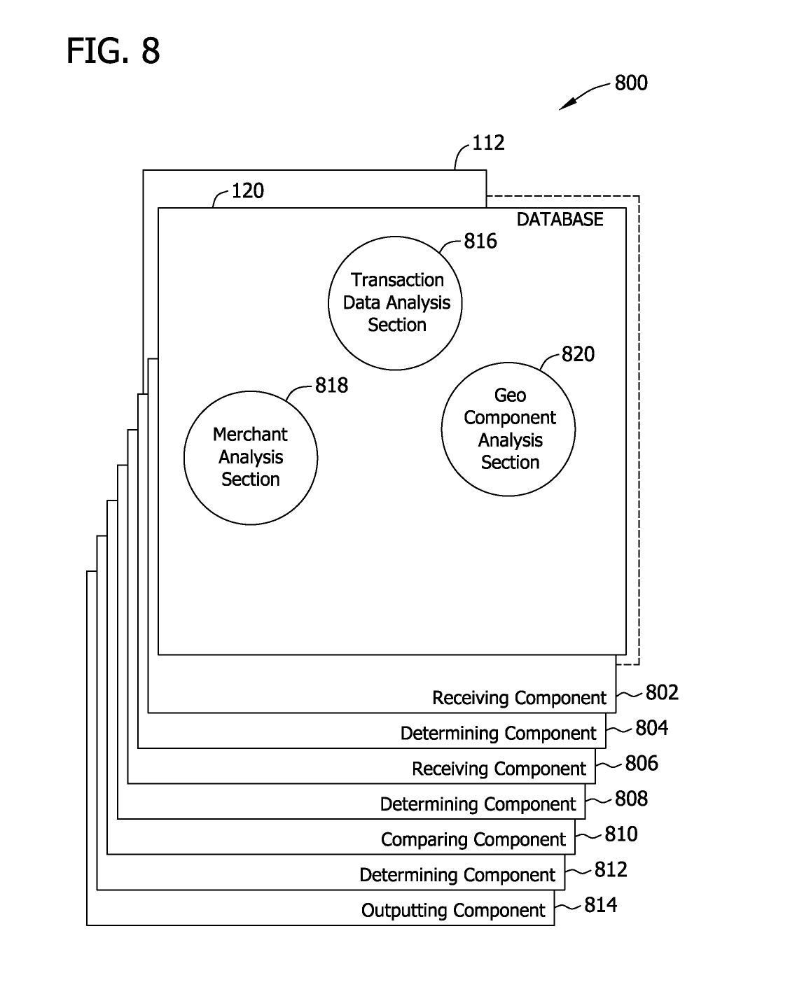

FIG. 8 is a diagram 800 of components of one or more example computing devices that may be used in the environment shown in FIG. 6. FIG. 8 further shows a configuration of databases including at least database 120 (shown in FIG. 2). Database 120 is coupled to several separate components communicatively coupled to geo-component fraud evaluation module 117, which perform specific tasks.

Geo-component fraud evaluation module 117 includes a receiving component 802 for receiving card-present payment card transaction data (including ordinary transaction data and geolocation data). Geo-component fraud evaluation module 117 also includes a determining component 804 for determining a home activity region for a cardholder 22. Geo-component fraud evaluation module 117 also includes a receiving component 806 for receiving a payment card transaction authorization request from a merchant. Geo-component fraud evaluation module 117 also includes a determining component 808 for determining a payment card activity location of the received payment card transaction authorization request. Geo-component fraud evaluation module 117 also includes a comparing component 810 for comparing the determined payment card activity location to the determined home activity region. Geo-component fraud evaluation module 117 also includes a determining component 812 for determining if the determined payment card activity location is within the determined home activity region using a at least one of a selectable threshold and a determined threshold. Geo-component fraud evaluation module 117 also includes a outputting component 814 for outputting a score for the received payment card transaction authorization request.

In an exemplary embodiment, database 120 is divided into a plurality of sections, including but not limited to, a transaction data analysis section 816, a merchant analysis section 818, and a geo-component analysis section 820. These sections within database 120 are interconnected to update and retrieve the information as required.

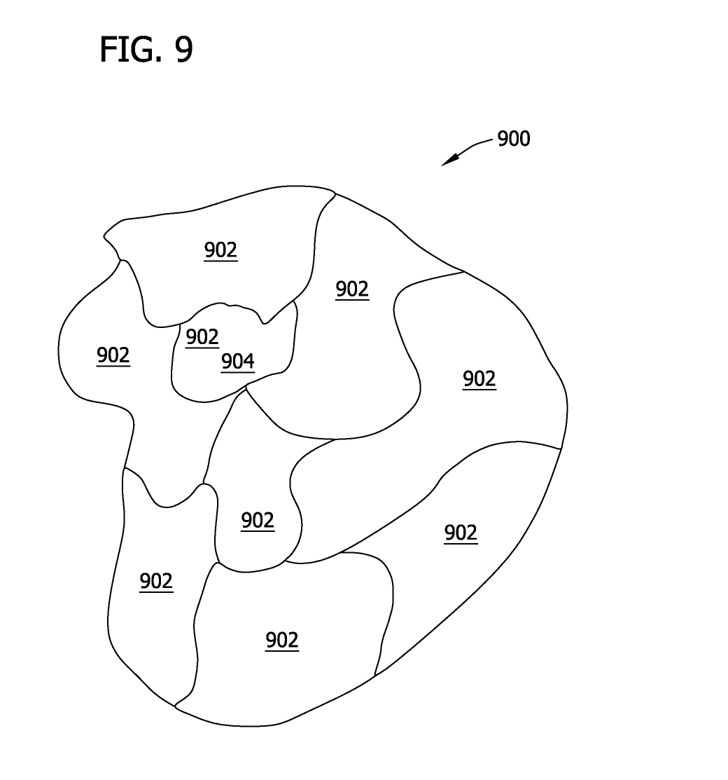

FIG. 9 is an illustration of a heat map 900 in accordance with an example embodiment of the present disclosure. In the example embodiment, heat map regions 902 including a cardholder home activity region 904 are scored for the propensity of fraud to occur in each region. For example, incidences of fraud at merchants in each region may be tallied and each region ranked based on the tally. In various embodiments, boundaries of heat map regions 902 may or may not coincide with other region boundaries used in other fraud analyses performed. In various embodiments, each heat map region 902 is indicated visually by the propensity for fraud in each region. For example, a color gradient may be used to indicate different levels of fraud occurring in each region. However, shading, hatching, and other visual representations may be used. In other embodiments, no visual display of heat map 900 is used. Heat map 900 may be used only by geo-component fraud evaluation module 117 in the fraud analysis and not displayed at all.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by for example, processors 205 and 305, including RAM memory, ROM memory, EPROM memory, EEPROM memory, and non-volatile RAM (NVRAM) memory. The above memory types are examples only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product (e.g., an article of manufacture, according to the discussed embodiments of the disclosure). The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the terms “software” and “firmware” are interchangeable, and include any computer program stored in memory for execution by devices that include, without limitation, mobile devices, clusters, personal computers, workstations, clients, and servers.

As used herein, the term “computer” and related terms (e.g., “computing device”), are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “cloud computing” and related terms (e.g., “cloud computing devices”) refers to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” refers to any of computing device which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The above-described embodiments of a method and system of evaluating a geo-component of payment card transactions in a fraud detection system provides a cost-effective and reliable means for correlating a current purchase transaction location to a region in which a cardholder typically shops. More specifically, the methods and systems described herein facilitate establishing a home region for a cardholder based at least partially the cardholder's previous transaction history and an industry in which the merchant participates. In addition, the above-described methods and systems facilitate comparing the cardholder's home region to the location of the current transaction. As a result, the methods and systems described herein facilitate automatically evaluating a card-present transaction for fraud based on a geo-component of the cardholder's transaction history and the current transaction location in a cost-effective and reliable manner.

This written description uses examples to describe the disclosure, including the best mode, and also to enable any person skilled in the art to practice the disclosure, including making and using any devices or systems and performing any incorporated methods. The patentable scope of the application is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-based method for evaluating a card-present payment card transaction for fraud, the method implemented using a computer device coupled to a memory device, the method comprising:
determining a home activity region for a cardholder using historical card-present payment card transaction data for the cardholder;
receiving a payment card transaction authorization request, the authorization request including an identification of an account associated with a payment card used in the payment card transaction;
determining a payment card activity location of the received payment card transaction authorization request;
comparing the determined payment card activity location to the determined home activity region;
determining if the determined payment card activity location is within the determined home activity region using at least one of a selectable threshold and a determined threshold;
if the determined payment card activity location is determined to be outside of the determined home activity region, determining if the determined payment card activity location is within a determined temporary home activity region; and
outputting a score for the received payment card transaction authorization request based on the determination of whether the payment card activity location is within the determined home activity region.

2. The computer-based method of claim 1, further comprising storing card-present payment card transaction data received from a plurality of merchants for a cardholder associated with a unique primary account number.

3. The computer-based method of claim 2, wherein determining a home activity region for a cardholder comprises determining a home activity region using the stored card-present payment card transaction data.

4. The computer-based method of claim 2, further comprising determining a temporary home activity region using a portion of the stored card-present payment card transaction data defined by a determined recent time period, the temporary home activity region being geographically spaced from the home activity region.

5. The computer-based method of claim 4, wherein outputting a score for the received payment card transaction authorization request comprises adjusting the score based on a determination that the payment card activity location is within the temporary home activity region.

6. The computer-based method of claim 1, wherein determining a home activity region for a cardholder comprises determining a home activity region for each of a plurality of categories of industry to which the merchant belongs.

7. The computer-based method of claim 1, wherein determining a home activity region for a cardholder comprises determining a geolocation of the home activity region.

8. The computer-based method of claim 1, wherein determining a home activity region for a cardholder comprises determining a geographical centroid of the home activity region.

9. The computer-based method of claim 8, wherein comparing the determined payment card activity location to the determined home activity region comprises:
determining a distance between the determined payment card activity location and the geographical centroid of the home activity region; and
comparing the determined distance to a threshold.

10. The computer-based method of claim 9, wherein determining if the determined payment card activity location is within the determined home activity region comprises determining if the determined payment card activity location is within the determined home activity region using a at least one of a selectable threshold and a determined threshold.

11. The computer-based method of claim 1, further comprising generating a fraud heat-map including fraud information for each of the merchants and based on a geo-location of the merchant.

12. The computer-based method of claim 11, further comprising determining fraud information for each of the merchants from the historical card-present payment card transaction data.

13. The computer-based method of claim 12, wherein outputting a score for the received payment card transaction authorization request comprises outputting a score for the received payment card transaction authorization request based on the determination of whether the payment card activity location is within the determined home activity region and a determination of the propensity of fraud in the region where the transaction occurred.

14. A computer system for processing data, the computer system comprising a memory device and a processor in communication with the memory device, the computer system programmed to:
store card-present payment card transaction data received from a plurality of merchants for a cardholder associated with a unique primary account number;
determine a home activity region of a cardholder using the stored card-present payment card transaction data;
receive a payment card transaction authorization request, the authorization request including an identification of an account associated with a payment card used in the payment card transaction;
determine a payment card activity location of the received payment card transaction authorization request;
compare the determined payment card activity location to the determined home activity region;
determine if the determined payment card activity location is within the determined home activity region using a at least one of a selectable threshold and a determined threshold; and
output a score for the received payment card transaction authorization request based on the determination of whether the payment card activity location is within the determined home activity region.

15. The computer system of claim 14, wherein determining a home activity region for a cardholder comprises determining a geolocation of the home activity region.

16. The computer system of claim 14, wherein determining a home activity region for a cardholder comprises determining a geographical centroid of the home activity region.

17. The computer system of claim 16, wherein comparing the determined payment card activity location to the determined home activity region comprises:
determining a distance between the determined payment card activity location and the geographical centroid of the home activity region; and
comparing the determined distance to a threshold.

18. The computer system of claim 17, wherein determining if the determined payment card activity location is within the determined home activity region comprises determining if the determined payment card activity location is within the determined home activity region using a at least one of a selectable threshold and a determined threshold.

19. One or more non-transitory computer-readable storage media having computer-executable instructions embodied thereon, wherein when executed by at least one processor, the computer-executable instructions cause the processor to:
store card-present payment card transaction data received from a plurality of merchants for a cardholder associated with a unique primary account number;
determine a home activity region of a cardholder using the stored card-present payment card transaction data;
receive a payment card transaction authorization request from a merchant point of sale (POS) device, the authorization request including an identification of an account associated with a payment card used in the payment card transaction;
determine a payment card activity location of the received payment card transaction authorization request;
compare the determined payment card activity location to the determined home activity region;
determine if the determined payment card activity location is within the determined home activity region using a at least one of a selectable threshold and a determined threshold; and
output a score for the received payment card transaction authorization request based on the determination of whether the payment card activity location is within the determined home activity region.

20. The computer-readable storage media of claim 19, wherein the computer-executable instructions further cause the processor to determine a temporary home activity region using a portion of the stored card-present payment card transaction data defined by a determined recent time period, the temporary home activity region being geographically spaced apart from the home activity region.

21. The computer-readable storage media of claim 20, wherein the computer-executable instructions further cause the processor to adjust the score based on a determination that the payment card activity location is within the temporary home activity region.

22. The computer-readable storage media of claim 19, wherein the computer-executable instructions further cause the processor to determine a home activity region for each of a plurality of categories of industry to which the merchant belongs.

23. The computer-readable storage media of claim 19, wherein the computer-executable instructions further cause the processor to determine a geolocation of the home activity region.
